(19) United States
(12) Patent Application Publication
(10) Pub. No.: US 2011/0032995 A1
(43) Pub. Date: Feb. 10, 2011

(54) VIDEO ENCODING AND DECODING DEVICE

(75) Inventors: Tien Ping Chua, Singapore (SG); Mi Michael Bi, Singapore (SG)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/937,159

(22) PCT Filed: Apr. 22, 2009
(86) PCT No.: PCT/JP2009/001850

§ 371 Date: Oct. 8, 2010

(30) Foreign Application Priority Data
Apr. 30, 2008 (JP) 2008-119267

(51) Int. Cl. H04N 7/12

(52) U.S. Cl. 375/240.24; 375/E07.027

(57) ABSTRACT

Provided is a video encoding and decoding device which can use limited memory resources to maximize system performance. After a direct memory access means (160) of a motion-compensation device (101) generates a DMA request after an interpolation complete was received from an interpolation means (180), and a DMA ACK was received from a memory access arbitration means (110), a video encoding and decoding device (100) receives a plurality of DMA input data in accordance with the maximum DMA burst constraint and the block buffer size constraint, and generates the block memory address for storing the reference pixel data in a variable size block buffer (170) in accordance with the decoding parameters, the calculation process level Lc, the maximum DMA burst constraint, and the block buffer size constraint.

### TECHNICAL FIELD

The present invention relates to a video coding and decoding apparatus having a motion compensation device using motion compensation in a video decoder.

### BACKGROUND ART

Digitization of multimedia-related information has accelerated in recent years, and has been accompanied by an increasing demand for video information of higher image quality. A specific example that can be mentioned is the transition from conventional SD (standard definition) of 720×480 pixels to HD (high definition) of 1920×1080 pixels in broadcast and laser storage media. However, this demand for higher image quality has led simultaneously to an increase in system complexity and decoding performance. Therefore, efficient system architectures that surpass conventional performance capabilities and yet is able to keep cost at a low level have been sought.

Use of motion compensation in a video coder has a number of significant advantages. Based on persistence of vision, a television signal has to be scanned at a certain speed (e.g. 30 or 60 frames per second). However, in many applications including HDTV, there is a large amount of redundancy between frames. This redundancy is reduced by using motion compensation in a video coder, so that it is possible to increase the compression rate of a video signal.

A variety of different algorithms can be used for a motion estimation method of estimating the motion between a pixel block in the current frame and a pixel block in the previous frame stored in a frame memory. For example, a pixel recursive algorithm is disclosed in Non-Patent Literatures 1 and 2. In addition, a block matching algorithm is described in Non-Patent Literature 3.

All of these algorithms require retrieval of pixels in the previously decoded frame from a frame buffer. In order to encode a high-resolution video signal in real time, these frame memories must be accessed at a high speed. On the other hand, in certain applications, especially in mobile terminal applications, a device has to be driven by a relatively lower system clock rate, as compared to high-end applications such as high definition digital TVs, to keep the system cost and power consumption low.

Therefore, a need exists for a buffering mechanism for use with motion compensation that does not create a performance bottleneck without adding undue complexity to a video decoder.

Patent Literature 1 discloses efficient motion compensation methods, “Efficient methods of performing motion compensation based decoding and recording of compressed video bitstreams”. In the invention described in Patent Literature 1, the efficiency of motion compensation is improved by increasing on-chip memory usage. A reference window is created in such a way that reference frame portions required for motion compensation are contained in an on-chip memory.

### CITATION LIST

### Patent Literature

### PTL 1

U.S. Pat. No. 7,218,842

### Non-Patent Literature

### NPL 1

“Motion Compensation Television Coding: Part I”, BSTT, Vol. 58, pp. 631-670, March, 1979

### NPL 2

K. A. Probhu et al., “Pel Recursive Motion Compensated Color Codecs”, Proc ICC 82, p. 2G. 8.1-8.5, Philadelphia, Pa., June 1982

### NPL 3

A block matching algorithm is disclosed in J. R. Jain et al., “Displacement Measurement and Its Application in Interframe Image Coding”, IEEE Trans. on Comm., Vol. COM-29, p. 1799-1808, December 1981

### SUMMARY OF INVENTION

### Technical Problem

However, the video coding and decoding apparatus provided with this conventional motion compensation method has the following problems.

That is, motion compensation requires retrieval of pixels in the previously decoded frame from a frame buffer. In order to encode a high-resolution video signal in real time, these frame memories must be accessed at high speed. On the other hand, in certain applications, especially in mobile terminal applications, a device has to be driven by relatively lower system clock rate, as compared to high-end applications such as high definition digital TVs, to keep the system cost and power consumption low.

In addition, with the motion compensation method described in Patent Literature 1, although the efficiency of motion compensation is improved by having a configuration to contain reference frame portions required for motion compensation in an on-chip memory, there is a disadvantage of requiring a large memory space for storing portions of reference frames.

It is therefore an object of the present invention to provide a video coding and decoding apparatus allowing the system performance to be optimized using limited memory resources.

### Solution to Problem

The video coding and decoding apparatus according to the present invention having a motion compensation device using motion compensation in a video decoder adopts a configuration to include: a plurality of video decoder engines; a plurality of engine direct memory access buses connected to the plurality of video decoder engines; a frame buffer; a main direct memory access bus connected to the frame buffer; a motion compensation device that issues a direct memory access request according to decoding parameters, computation level Lc, a maximum direct memory access burst constraint and a block buffer size constraint, receives a plurality of direct memory access input data after receiving a direct memory access acknowledgement, issues a direct memory access completion, computes interpolated data according to a decoding mode specified by the decoding parameters and outputs the interpolated data to one of the plurality of video decoder engines; and a memory access arbitration section that receives the direct memory access request from the motion compensation device, receives direct memory access requests from the plurality of video decoder engines through the engine direct memory access buses, sets priorities to the direct memory access requests, sends the direct memory access acknowledgement to each of the motion compensation device and the plurality of video decoder engines according to a pre-defined direct memory access priority list, makes direct memory access input data and direct memory access output data streams, provides the direct memory access input data to the motion compensation device, reads data from the frame buffer and writes data to the frame buffer through the main direct memory access bus.

### ADVANTAGEOUS EFFECTS OF INVENTION

According to the present invention, a motion compensation device being able to flexibly configure the system performance and the memory size is provided. This enables the system performance to be either pre-defined, or automatically configured to optimize the overall system processing throughput in real-time in order to balance the performance between the motion compensation device and other video decoder engines. In addition, it is possible to configure the size of an on-chip memory for storing reference pixel data, according to the system cost constraint applied to the motion compensation device. Moreover, flexible configurations for performing at least one of padding, word-aligning and chrominance component de-interleaving enable trade-off of the system complexity between a DMA controller and computation logics, and enable the balance of the system performance between a DMA controller and computation logics. This allows a motion compensation device and a video coding and decoding apparatus with a flexible mechanism to maximize the system performance using limited memory resources instead of using a large on-chip data memory operating at a high frequency.

### BRIEF DESCRIPTION OF DRAWINGS

FIG. 1 is a block diagram showing a configuration of a video coding and decoding apparatus according to Embodiment 1 of the present invention;

FIG. 2 is a drawing showing a detailed configuration of a video coding and decoding apparatus according to Embodiment 2 of the present invention;

FIG. 3 is a drawing showing a detailed configuration of a video coding and decoding apparatus according to Embodiment 3 of the present invention;

FIG. 4 is a drawing showing a detailed configuration of a video coding and decoding apparatus according to Embodiment 4 of the present invention;

FIG. 5 is a flowchart showing operations of a DMA command generator in a motion compensation device in the video coding and decoding apparatus according to Embodiment 4 of the present invention;

FIG. 6 is a flowchart showing operations of the DMA command generator in the motion compensation device in the video coding and decoding apparatus according to Embodiment 4 of the present invention;

FIG. 7 is a block diagram showing a configuration of a video coding and decoding apparatus according to embodiment 5 of the present invention; and

FIG. 8 is a block diagram showing a configuration of a video coding and decoding apparatus according to embodiment 6 of the present invention.

### DESCRIPTION OF EMBODIMENTS

Now, embodiments of the present invention will be described in detail with reference to the accompanying drawings.

### Embodiment 1

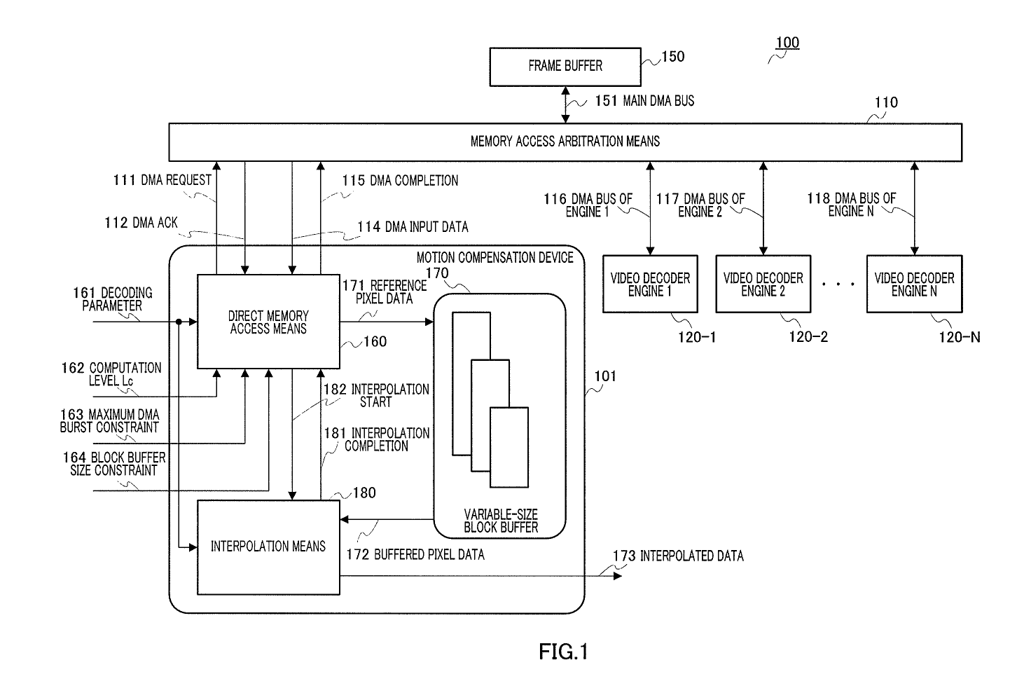

FIG. 1 is a diagram showing the configuration of a video coding and decoding apparatus according to Embodiment 1 of the present invention. The present embodiment is an example where the present invention is applied to a video coding and decoding apparatus including a frame buffer, a plurality of video decoder engines, a plurality of engine DMA buses connected to the plurality of video decoder engines and a motion compensation device using motion compensation.

In FIG. 1, video coding and decoding apparatus 100 is configured to include motion compensation device 101, memory access arbitration means 110, N video decoder engines 120-1, 120-2, . . . , 120-N and frame buffer 150.

Motion compensation device 101 has input terminals to receive decoding parameter 161, computation level Lc 162, maximum DMA burst constraint 163, block buffer size constraint 164, DMA ACK 112, DMA input data 114 and interpolation completion 181; issues DMA request 111 according to decoding parameter 161, computation level Lc 162, maximum DMA burst constraint 163 and block buffer size constraint 164; receives a plurality of DMA input data 114 after receiving DMA ACK 112; issues DMA completion 115; computes interpolated data according to the decoding mode specified by decoding parameter 161; and outputs the interpolated data to one of multiple decoder engines 120-1, 120-2, . . . , 120-N.

Memory access arbitration means 110 receives DMA request 111 from motion compensation device 101; receives DMA requests from multiple video decoder engines 120-1, 120-2, . . . , 120-N through engine DMA buses 116 to 118; sets priorities to these DMA requests; sends DMA ACK 112 to each of motion compensation device 101 and multiple video decoder engines 120-1, 120-2, . . . , 120-N according to a pre-defined DMA priority list; makes DMA input data and DMA output data streams, provides DMA input data 114 to motion compensation device 101; reads data from frame buffer 150 and writes data to frame buffer 150 through main DMA bus 151.

Multiple video decoder engines 120-1, 120-2, . . . , 120-N are connected to memory access arbitration means 110 through engine DMA buses 116 to 118.

Frame buffer 150 is an external system memory shared with multiple video decoder engines 120-1, 120-2, . . . , 120-N and is connected to memory access arbitration means 110 through main DMA bus 151.

Motion compensation device 101 has direct memory access means 160, variable-size block buffer 170 and interpolation means 180 and is designed with flexible performance and memory size configurations.

Direct memory access means 160 generates a DMA request after receiving interpolation completion 181 from interpolation means 180; receives a plurality of DMA input data, according to the maximum DMA burst constraint and the block buffer size constraint after receiving DMA ACK 112 from memory access arbitration means 110; generates block memory addresses to store reference pixel data 171 in variable-size block buffer 170, according to the decoding parameters, the computation level Lc, the maximum DMA burst constraint and the block buffer size constraint; outputs reference pixel data 171 to variable-size block buffer 170; generates DMA completion 115 after receiving the plurality of DMA input data from memory access arbitration section 110; and generates interpolation start 182.

Variable-size block buffer 170 stores reference pixel data 171 retrieved from frame buffer 150 through direct memory access and provides buffered pixel data to interpolation means 180. Variable-size block buffer 170 can be configured to various pre-defined memory sizes according to system cost and system performance requirements.

Interpolation means 180 computes interpolated data according to the decoding mode specified through decoding parameters and outputs the interpolated data to one of multiple video decoder engines 120-1, 120-2, . . . , 120-N. To be more specific, interpolation means 180 has input terminals to receive decoding parameters, interpolation start and a plurality of buffered pixel data 172, computes multiple interpolated data 173 by applying pre-defined interpolation filters to the plurality of buffered pixel data, and generates interpolation completion 181 after computing all interpolated data 173.

Now, operations of the video coding and decoding apparatus configured as described above will be explained.

After receiving DMA ACK 112, motion compensation device 101 receives multiple DMA input data 114 and then issues DMA completion 115. Motion compensation device 101 computes interpolated data 173 according to the decoding mode specified by decoding parameter 161. Motion compensation device 101 outputs interpolated data 173 to one of video decoder engines through one of its own output terminals.

Memory access arbitration means 110 receives DMA requests 111 from motion compensation device 101. In addition, memory access arbitration means 110 receives DMA requests from multiple video decoder engines 120-1, 120-2, . . . , 120-N through engine DMA buses 116, 117 and 118, respectively, sets priorities to these DMA requests, sends DMA ACK 112 to each of motion compensation device 101 and multiple decoder engines 120-1, 120-2, . . . , 120-N according to a pre-defined DMA priority list. Then, memory access arbitration means 110 makes DMA input data and DMA output data streams, provides DMA input data 114 to motion compensation device 100 reads data from frame buffer 150 and writes data to frame buffer 150 through main DMA bus 151.

Multiple video decoder engines 120-1, 120-2, . . . , 120-N are connected to memory access arbitration means 110 through engine DMA buses 116, 117 and 118, respectively. Frame buffer 150 is connected to memory access arbitration means 110 through main DMA bus 151.

Next, operations of motion compensation device 101 will be explained.

Direct memory access means 160 generates a DMA request according to maximum DMA burst constraint 163 and block buffer size constraint 164, receives a plurality of DMA input data, coordinates DMA accesses and interpolation means 180 and generates addresses to store reference pixel data 171 retrieved from frame buffer 150 through DMA, in variable-size block buffer 170.

To be more specific, after receiving interpolation completion 181 from interpolation means 180, direct memory access means 160 generates DMA request 111 and issues the generated DMA request to memory access arbitration means 110. After receiving DMA ACK 112 from memory access arbitration means 110, direct memory access means 160 receives a plurality of DMA input data 114 from memory access arbitration means 110, according to maximum DMA burst constraint 163 and block buffer size constraint 164. Direct memory access means 160 generates block memory addresses to store reference pixel data 171 in variable-size block buffer 170, according to decoding parameters 161, computation level Lc 162, maximum DMA burst constraint 163 and block buffer size constraint 164. Direct memory access means 160 outputs reference pixel data 171 to variable-size block buffer 170. After receiving a plurality of DMA input data 114, direct memory access means 160 generates DMA completion 115 and then generates interpolation start 182.

Variable-size block buffer 170 is an on-chip memory to store reference pixel data retrieved from external frame buffer 150 through direct memory access, and provides buffered pixel data 172 to interpolation means 180. Variable-size block buffer 170 can be configured to various pre-defined memory sizes according to system cost and system performance requirements.

Interpolation means 180 computes a plurality of interpolated data 173 by applying pre-defined interpolation filters to buffered pixel data 172, and generates interpolation completion 181 after computing all interpolated data 173.

As described above in detail, according to the present embodiment, video coding and decoding apparatus 100 generates DMA request 111 after direct memory access means 160 receives interpolation completion 181 from interpolation means 180, receives a plurality of DMA input data, according to maximum DMA burst constraints and block buffer size constraints, after receiving a DMA ACK from memory access arbitration means 110, and generates block memory addresses to store reference pixel data in variable-size block buffer 170, according to decoding parameters, computation level Lc, maximum DMA burst constraints and block buffer size constraints.

By this means, direct memory access means 160 makes it possible to form burst DMA by automatically combining a plurality of small DMA accesses or automatically split a large burst DMA into a plurality of small sized DMA accesses. In addition, by pre-defining the system performance or automatically optimizing the overall system processing throughput in real-time, it is possible to balance the data bus occupation time and the bus occupation time to access frame buffer 150 between motion compensation device 101 and other multiple video decoder engines 120-1, 120-2, . . . , 120-N. This allows motion compensation device 101 with a flexible mechanism to maximize the system performance using limited memory resources instead of using a large on-chip data memory operating at a high frequency.

As described above, motion compensation device 101 with a high performance for video decoding can be realized, so that video coding and decoding apparatus 100 is able to operate in real time by using motion compensation device 101 for high-resolution video requiring motion compensation. Moreover, as described above, motion compensation device 101 can reduce the cost of the system memory required for motion compensation, so that it is possible to improve the cost performance of the motion compensation system.

### Embodiment 2

With Embodiment 2, an example of the motion compensation device will be described in detail.

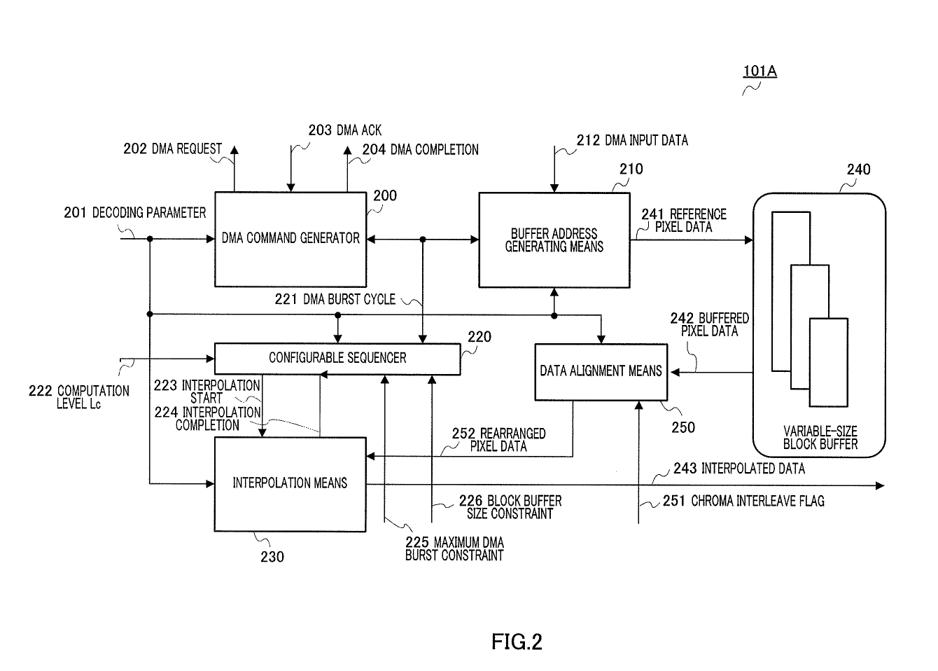

FIG. 2 is a drawing showing the detailed configuration of a motion compensation device in a video coding and decoding apparatus according to Embodiment 2 of the present invention. Motion compensation device 101A according to the present embodiment is applied instead of motion compensation device 101 shown in FIG. 1.

In FIG. 2, motion compensation device 101A is composed of six components that are DMA command generator 200, buffer address generating means 210, configurable sequencer 220, interpolation means 230, variable-size block buffer 240 and data alignment means 250.

DMA command generator 200 has input terminals to receive decoding parameters, a DMA ACK and DMA burst cycles, generates DMA requests, receives a DMA ACK, counts the number of DMA requests and outputs DMA completion after a counter reaches the number of DMA burst cycles.

Buffer address generating means 210 has input terminals to receive decoding parameters, DMA input data and DMA burst cycles, derives block buffer addresses according to decoding parameters and DMA burst cycles and transfers DMA input data to a memory location in the variable-size block buffer through its reference pixel data terminal.

Configurable sequencer 220 has input terminals to receive decoding parameters, computation level Lc, maximum DMA burst constraints, block buffer size constraints and interpolation completion, derives DMA burst cycles according to the bitstream nature specified by decoding parameters, system performance limitation specified by maximum DMA constraint 225 and system resource limitation specified by block buffer size constraints and generates interpolation start to activate interpolation means 230 at the time being dynamically configured according to system performance and resource limitations.

Interpolation means 230 computes interpolated data according to the decoding mode specified by decoding parameters and outputs the interpolated data to one of multiple video decoder engines 120-1, 120-2, . . . , 120-N. To be more specific, interpolation section 230 has input terminals to receive decoding parameters, interpolation start and plurality of rearranged pixel data, computes a plurality of interpolated data by applying pre-defined interpolation filters to rearranged pixel data, generates interpolation completion after calculating all the interpolated data and outputs the interpolated data.

Variable-size block buffer 240 has a reference pixel data terminal to receive channeled DMA input data, stores the channeled DMA input data in a pre-defined location according to block buffer addresses and outputs buffered pixel data for motion compensation processing.

Data alignment means 250 has input terminals to receive decoding parameters, a chroma interleave flag and buffered pixel data/rearranges the buffered pixel data according to its location in the video frame, indicated by motion vectors as part of decoding parameters, and a chroma interleave flag indicating the chrominance data format in frame buffer 150, provides rearranged pixel data by padding frame boundary pixels, removes unuseful data by word boundary rearrangement, and, if the chroma interleave flag is set, separates interleaved chrominance components and makes chrominance component streams according to the designed chroma pixel data format in the frame buffer.

Now, operations of the video coding and decoding apparatus configured as described above will be explained.

DMA command generator 200 generates DMA requests 202 to memory access arbitration means 110 (FIG. 1), receives DMA ACK 203 from memory access arbitration means 110 (FIG. 1), counts the number of DMA requests 202 and, after the counter reaches the number of DMA burst cycles 221, outputs DMA completion 204 to memory access arbitration means 110 (FIG. 1).

Buffer address generating means 210 derives block buffer addresses according to decoding parameters 201 and DMA burst cycles 221 and transfers DMA input data 212 from memory access arbitration means 110 (FIG. 1) to a memory location in variable-size block buffer 240, as reference pixel data 241, through its reference pixel data terminal.

Configurable sequencer 220 generates interpolation start 223 to activate interpolation means 230 at the time being dynamically configured according to system performance and resource limitations.

Interpolation means 230 computes multiple interpolated data 243 by applying pre-defined interpolation filters to rearranged pixel data 252, generates interpolation completion 224 after computing all interpolated data 243, and outputs interpolated data 243.

Variable-size block buffer 240 receives channeled DMA input data, stores them in proper locations according to block buffer addresses and outputs buffered pixel data 242 for motion compensation processing.

Data alignment means 250 rearranges buffered pixel data 242 according to the location in the video frame, indicated by motion vectors as part of decoding parameters 201, and chroma interleave flag 251 indicating the chrominance data format in frame buffer 150 (FIG. 1). Data alignment means 250 provides rearranged pixel data 252 by padding frame boundary pixels and removes unuseful data by word boundary rearrangement. Then, if the chroma interleave flag is set, data alignment means 250 separates two interleaved chrominance components and makes chrominance component streams according to the designed chroma pixel data format in frame buffer 150.

As described above, according to the present embodiment, motion compensation device 101A has a configurable sequencer 220 to derive DMA burst cycles according to the bitstream nature specified by decoding parameters, system performance limitation specified by maximum DMA constraints and system resource limitation specified by block buffer size constraints and generate interpolation start to activate interpolation means 230 at the time being dynamically configured according to system performance and resource limitations. Therefore, motion compensation device 101A can adaptively allocate the number and size of data memory burst accesses to the data memory by dynamically monitoring data bus traffic, so that it is possible to achieve optimised data streaming between the computation means and limited memories inside and outside of motion compensation device 101A.

In addition, it is possible to pre-define the system performance based on the system performance limitation applied to motion compensation device 101A, so that it is possible to set the size of the on-chip memory to store reference pixel data according to the system resource limitation applied to the motion compensation device.

In addition, with the present embodiment, motion compensation device 101A has data alignment means 250, so that it is possible to perform data alignment including rearrangement of pixel data, removal of unuseful data, data streaming according to the chroma pixel data format and so forth, on pixel data 242 buffered by variable-size block buffer 240 configurable to various pre-defined memory size according to system cost and system performance requirements.

### Embodiment 3

With Embodiment 3, an example of the motion compensation device will be described in detail.

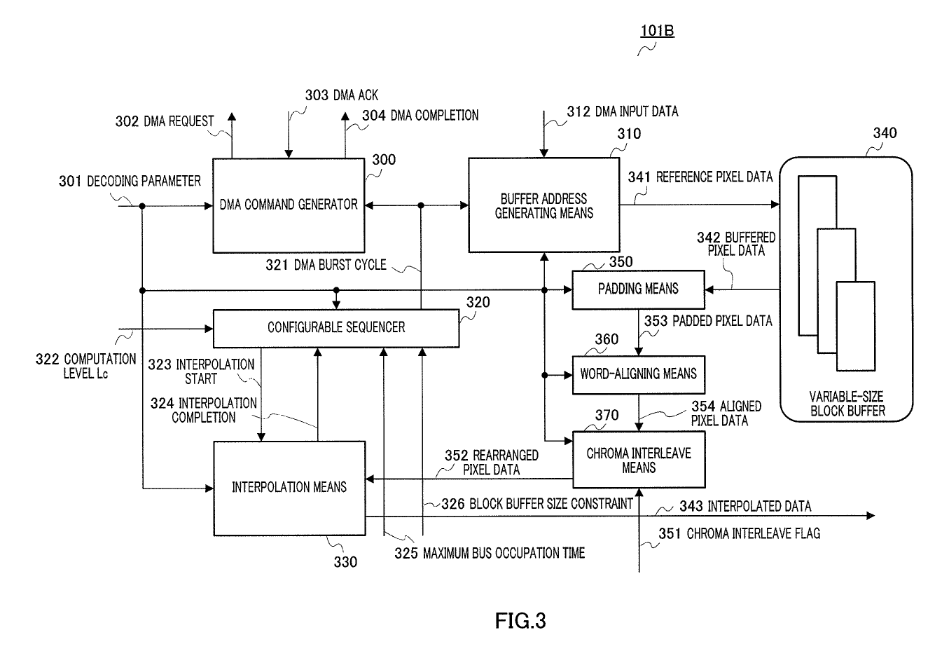

FIG. 3 is a drawing showing the detailed configuration of a motion compensation device in a video coding and decoding apparatus according to Embodiment 3 of the present invention. Motion compensation device 101B according to the present embodiment is applied instead of motion compensation device 101 shown in FIG. 1.

In FIG. 3, motion compensation device 101B is composed of eight components that are DMA command generator 300, buffer address generating means 310, configurable sequencer 320, interpolation means 330, variable-size block buffer 340, padding means 350, word-aligning means 360 and chroma interleave means 370.

DMA command generator 300 has input terminals to receive decoding parameters, a DMA ACK and DMA burst cycles, generates DMA requests, receives a DMA ACK, counts the number of DMA requests and outputs DMA completion after the counter reaches the number of DMA burst cycles.

Buffer address generating means 310 has input terminals to receive decoding parameters, DMA input data and DMA burst cycles, derives block buffer addresses according to decoding parameters and DMA burst cycles and transfers DMA input data to padding means 350 through its reference pixel data input terminal.

Configurable sequencer 320 has input terminals to receive decoding parameters, computation level Lc, a maximum bus occupation time, block buffer size constraints and interpolation completion, derives DMA burst cycles according to the bitstream nature specified by decoding parameters, system performance limitation specified by maximum DMA constraints and system resource limitation specified by block buffer size constraints, and generates interpolation start to activate interpolation means 330 at the time being dynamically configured according to system performance and resource limitations.

Interpolation means 330 computes interpolated data according to the decoding mode specified by decoding parameters and outputs interpolated data to one of multiple video decoder engines 120-1, 120-2, . . . , 120-N. To be more specific, interpolation means 330 has input terminals to receive decoding parameters, interpolation start and plurality of rearranged pixel data, computes a plurality of interpolated data by applying pre-defined interpolation filters to buffered pixel data, generates interpolation completion after computing all the interpolated data, and outputs the interpolated data.

Variable-size block buffer 340 has input terminals to receive reference pixel data and block buffer addresses from buffer address generating section 310, stores rearranged pixel data in proper locations according to block buffer addresses generated by the buffer address generating means, and outputs buffered pixel data to interpolation means 330 for motion compensation computation.

Padding means 350 has input terminals to receive decoding parameters and buffered pixel data, duplicates frame boundary pixel values for the buffered pixel data located outside video frame boundaries to generate padded pixel data, and judges whether the buffered pixel data are outside the video frame boundaries according to frame height and width parameters, motion vectors and the current macroblock position, block position or both positions specified by decoding parameters.

Word-aligning means 360 has input terminals to receive decoding parameters and padded pixel data from padding means 350, removes unuseful data if the first valid pixel data is not aligned with the word boundaries to generate aligned pixel data, and judges whether padded pixel data are aligned with the word boundaries according to sub-pixel positions indicated by motion vectors in decoding parameters.

Chroma interleave means 370 has input terminals to receive decoding parameters and aligned pixel data from word-aligning means 360, and, if a chroma interleave flag is set, separates interleaved chrominance components and makes chrominance component streams according to the designed chroma pixel data format in the frame buffer to generate rearranged pixel data.

Now, operations of the video coding and decoding apparatus configured as described above will be explained.

DMA command generator 300 generates DMA requests 302 for memory access arbitration means 110 (FIG. 1), receives DMA ACK 303 from memory access arbitration means 110 (FIG. 1), counts the number of DMA requests, and, after the counter reaches the number of DMA burst cycles 321, outputs DMA completion 304 to memory access arbitration means 110 (FIG. 1).

Buffer address generating means 310 derives block buffer addresses according to decoding parameters 301 and DMA burst cycles 321 and transfers DMA input data 312 from memory access arbitration means 110 (FIG. 1) to memory locations in variable-size block buffer 340 through its own reference pixel data terminal 341.

Configurable sequencer 320 derives DMA burst cycles 321 according to the bitstream nature specified by decoding parameters 301, system performance limitation specified by maximum bus occupation time 325 and system resource limitation specified by block buffer size constraint 326. Configurable sequencer 320 generates interpolation start 323 to activate interpolation means 330 at the time being dynamically configured according to system performance and resource limitations.

Interpolation means 330 computes multiple interpolated data 343 by applying pre-defined interpolation filters to rearranged pixel data 352, generates interpolation completion 324 after computing all the interpolated data, and outputs interpolated data 343.

Variable-size block buffer 340 receives channeled DMA input data, stores them in proper locations according to the block buffer addresses and outputs buffered pixel data 342 for motion compensation processing.

Padding means 350 duplicates frame boundary pixel values for buffered pixel data 342 located outside video frame boundaries to generate padded pixel data 353. Padding means 350 judges whether the buffered pixel data are outside video frame boundaries according to frame height and width parameters, motion vectors and the current macroblock position, block position or both positions specified by decoding parameters 301.

Word-aligning means 360 removes unuseful data if the first valid pixel data is not aligned with word boundaries to generate aligned pixel data 354. Word-aligning means 360 judges whether padded pixel data 353 are aligned with word boundaries according to the sub-pixel positions indicated by motion vectors in decoding parameters.

If a chroma interleave flag is set, chroma interleave means 370 separates two interleaved chrominance components and makes chrominance component streams according to the designed chroma pixel data format in frame buffer 150 (FIG. 1) to generate rearranged pixel data 352.

As described above, according to the present embodiment, motion compensation device 101B has padding means 350, word-aligning means 360 and chroma interleave means 370, and variable-size block buffer 340 provides buffered pixel data 342 to padding means 350. Motion compensation device 101B can configure padding, word-aligning and chrominance component interleaving after reference pixel data is stored in variable-size block buffer 340, and this enables trade-off of the system complexity between DMA controller and computation logics. In addition, in motion compensation device 101B, flexible configurations for performing padding, word-aligning or chrominance component de-interleaving enables the balance of system performance between the DMA controller and computation logics.

Here, with the present embodiment, although padding processing, word-aligning processing and chrominance component interleave processing are configured after reference pixel data is stored in variable-size block buffer 340, it is no problem to configure at least one processing.

### Embodiment 4

With Embodiment 3, padding processing, word-aligning processing and chrominance component interleave processing are performed after reference pixel data is stored in the variable-size block buffer. Each above-described processing may be performed before reference pixel data is stored in the variable-size block buffer. Embodiment 4 is an example where each processing is performed before reference pixel data is stored in the variable-size block buffer.

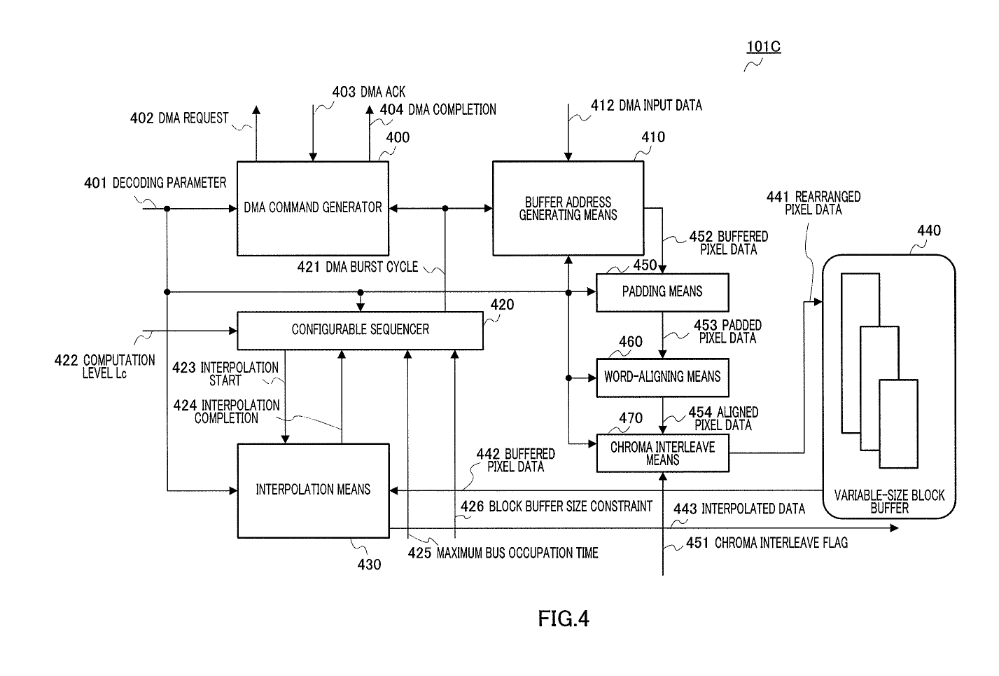

FIG. 4 is a drawing showing the detailed configuration of a motion compensation device in a video coding and decoding apparatus according to Embodiment 4 of the present invention. Motion compensation device 101C according to the present embodiment is applied instead of motion compensation device 101 shown in FIG. 1.

In FIG. 4, motion compensation device 101C is composed of eight components that are DMA command generator 400, buffer address generating means 410, configurable sequencer 420, interpolation means 430, variable-size block buffer 440, padding means 450, word-aligning means 460 and chroma interleave means 470.

DMA command generator 400 has input terminals to receive decoding parameters, a DMA ACK and DMA burst cycles, generates DMA requests, receives a DMA ACK, counts the number of DMA requests and outputs DMA completion after the counter reaches the number of DMA burst cycles.

Buffer address generating means 410 has input terminals to receive decoding parameters, DMA input data and DMA burst cycles, derives block buffer addresses according to decoding parameters and DMA burst cycles, and transfers DMA input data to memory locations in the variable-size block buffer through its reference pixel data input terminal.

Configurable sequencer 420 has input terminals to receive decoding parameters, computation level Lc, a maximum bus occupation time, block buffer size constraint and interpolation completion, allocates DMA burst cycles according to the bitstream nature specified by decoding parameters, system performance limitation specified by the maximum bus occupation time and system resource limitation specified by block buffer size constraints, and generates interpolation start to activate interpolation means 430 at the time being dynamically configured according to system performance and resource limitations.

Interpolation means 430 computes interpolated data according to the decoding mode specified by decoding parameters and outputs interpolated data to one of multiple video decoder engines 120-1, 120-2, . . . , 120-N. To be more specific, interpolation means 430 has input terminals to receive decoding parameters, interpolation start and plurality of buffered pixel data, computes a plurality of interpolated data by applying pre-defined interpolation filters to buffered pixel data, generates interpolation completion computing after all the interpolated data, and outputs the interpolated data.

Variable-size block buffer 440 has a pixel data terminal to receive rearranged pixel data 441, stores rearranged pixel data 441 in proper locations according to block buffer addresses and outputs buffered pixel data for motion compensation processing.

Padding means 450 has input terminals to receive decoding parameters and buffered pixel data, duplicates frame boundary pixel values for the buffered pixel data located outside video frame boundaries to generate padded pixel data, and judges whether the buffered pixel data are outside video frame boundaries according to frame height and width parameters, motion vectors and the current macroblock position, block position or both positions specified by decoding parameters.

Word-aligning means 460 has input terminals to receive decoding parameters and padded pixel data from padding means 450, removes unuseful data if the first valid pixel data is not aligned with the word boundaries to generate aligned pixel data, and judges whether padded pixel data are aligned with the word boundaries according to sub-pixel positions indicated by motion vectors in decoding parameters.

Chroma interleave means 470 has input terminals to receive decoding parameters and aligned pixel data from the word-aligning means, and, if a chroma interleave flag is set, separates interleaved chrominance components and makes chrominance component streams according to the designed chroma pixel data format in the frame buffer to generate rearranged pixel data.

Now, operations of the video coding and decoding apparatus configured as described above will be explained.

DMA command generator 400 generates DMA requests 402 to memory access arbitration means 110 (FIG. 1), receives DMA ACK 403 from memory access arbitration means 110 (FIG. 1), counts the number of DMA requests and outputs DMA completion 404 after the counter reaches the number of DMA burst cycles 421, to memory access arbitration means 110 (FIG. 1).

Buffer address generating means 410 derives block buffer addresses according to decoding parameters 401 and DMA burst cycles 421 and transfers DMA input data 412 from memory access arbitration means 110 (FIG. 1) to padding means 450, as buffered pixel data 452, through its reference pixel data input terminal.

Configurable sequencer 420 derives DMA burst cycles 421 according to the bitstream nature specified by decoding parameters, system performance limitation specified by maximum bus occupation time 425 and system resource limitation specified by block buffer size constraint 426. Configurable sequencer 420 generates interpolation start 423 to activate interpolation means 430 at the time being dynamically configured according to according to system performance and resource limitations.

Interpolation means 430 computes multiple interpolated data 443 by applying pre-defined interpolation filters to buffered pixel data 442, generates interpolation completion 424 after computing all the interpolated data and outputs interpolated data 443.

Variable-size block buffer 440 stores rearranged pixel data 441 in proper locations according to block buffer addresses generated by buffer address generating means 410 and outputs buffered pixel data 442 for motion compensation computation.

Padding means 450 judges whether buffered pixel data 452 are outside video frame boundaries according to frame height and width parameters, motion vectors and the current macroblock position, block position or both positions specified by decoding parameters.

Word-aligning means 460 judges whether padded pixel data 453 are aligned with word boundaries according to sub-pixel positions indicated by motion vectors in decoding parameters.

If a chroma interleave flag is set, chroma interleave means 470 separates two interleaved chrominance components and makes chrominance component streams according to the designed chroma pixel data format in frame buffer 150 (FIG. 1) to generate rearranged pixel data 441.

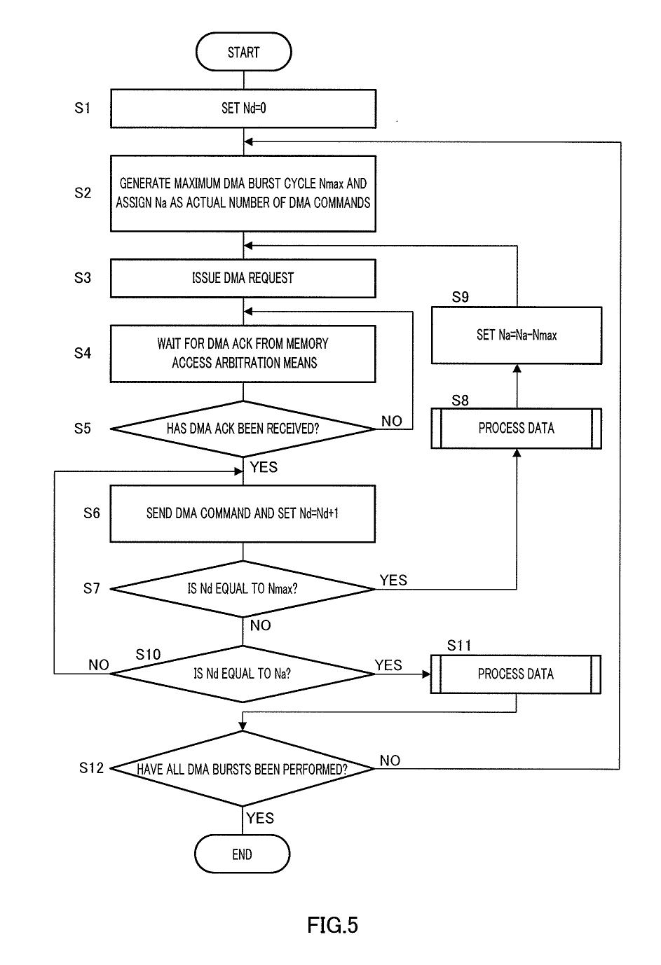

FIG. 5 is a flowchart showing operations of DMA command generator 400 in motion compensation device 101C. In the figure, S indicates each step in the flow.

First, in step S1, DMA command generator 400 sets DMA burst cycle Nd=0.

Next, in step S2, DMA command generator 400 generates maximum DMA burst cycle Nmax and assigns Na as the actual number of DMA commands.

In step S3, DMA command generator 400 issues DMA request 402 to memory access arbitration means 110 (FIG. 1).

In step S4, DMA command generator 400 waits for DMA ACK 403 from memory access arbitration means 110 (FIG. 1).

In step S5, DMA command generator 400 checks if DMA ACK 403 has received, moves to step S6 if DMA ACK 403 has been received, or if DMA ACK 403 has not been received, returns to step 4.

In step S6, DMA command generator 400 sends a DMA command to memory access arbitration means 110 (FIG. 1) and sets Nd=Nd+1.

In step S7, DMA command generator 400 checks if Nd is equal to Nmax, and moves to step S8 when Nd=Nmax, or if Nd is not equal to Nmax, moves to step S10.

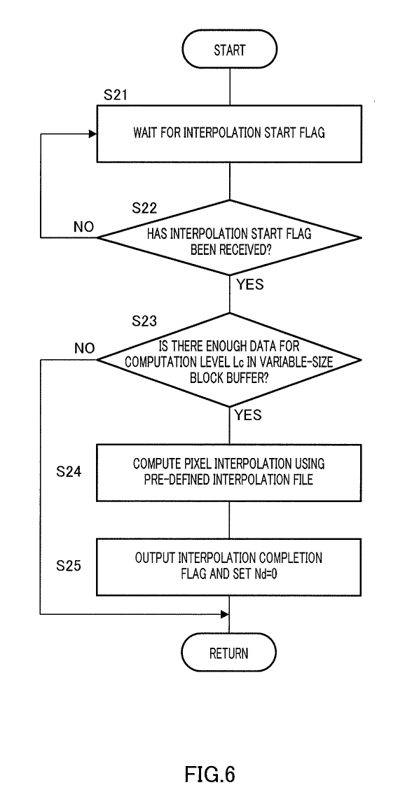

In step S8, DMA command generator 400 processes data, and, in step S9, sets Na=Na−Nmax and returns to step S3. This data processing will be described in detail later with FIG. 6.

In step S10, DMA command generator 400 checks if Nd is equal to Na.

If Nd is equal to Na, DMA command generator 400 processes data in step S11 and moves to step S12. If Nd is not equal to Na, DMA command generator 400 returns to the above-described step S6.

In step S12, DMA command generator 400 checks if all DMA bursts have been processed. If all the DMA bursts have been processed, this flow is finished, and, if all the DMA bursts have not been processed, DMA command generator 400 returns to step S2 and repeats the above-described processing until completion of processing of all bursts.

FIG. 6 is a flowchart showing operations of data processing steps shown in FIG. 5. This flow describes step S8 and step S11 in FIG. 5 in detail.

If Nd is inputted in step S8 or step S11 in FIG. 5, interpolation means 430 waits for an interpolation start flag in step S21.

In step S22, interpolation means 430 checks if the interpolation start flag has been received. If the interpolation flag has not been received, interpolation means 430 returns to the above-described step S21 and waits for an interpolation start flag.

If the interpolation flag has been received, interpolation means 430 checks if there are enough data in variable-size block buffer 440 for computation level Lc in step S23.

If there are enough data in variable-size block buffer 440 for computation level Lc, interpolation means 430 computes pixel interpolation using pre-defined interpolation filters in step S24. If there are not enough data in variable-size block buffer 440 for computation level Lc, interpolation means 430 returns to step S8 or step S11 in FIG. 5.

In step S25, interpolation means 430 generates an interpolation completion flag in step S25, sets Nd=0 and returns to step S8 or step S11 in FIG. 5.

As described above, according to the present embodiment, motion compensation device 101C has padding means 450, word-aligning means 460 and chroma interleave means 470, and variable-size block buffer 440 receives, as input, pixel data 441 realigned by chroma interleave means 470 and outputs buffered pixel data 442 to interpolation means 430. Motion compensation device 101C can configure padding processing, word-aligning processing and chrominance interleave processing before reference pixel data is stored in variable-size block buffer 440, and enables trade-off of the system complexity between the DMA controller and computation logics. Moreover, motion compensation device 101C flexibly configure to perform padding, word-aligning and chrominance component de-interleaving, and therefore enables the balance of the system performance between the DMA controller and computation logics.

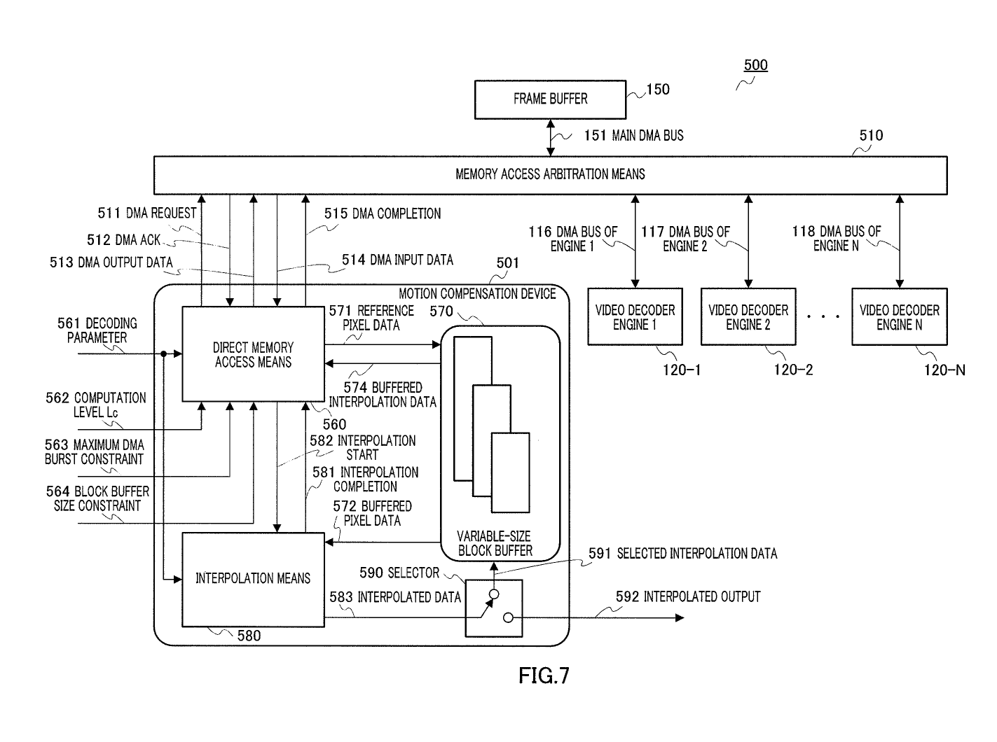

FIG. 7 is a drawing showing the configuration of a video coding and decoding apparatus according to Embodiment 5 of the present invention. The same components as in FIG. 1 are assigned the same reference numerals and descriptions will be omitted.

In FIG. 7, video coding and decoding apparatus 500 is configured to include motion compensation device 501, memory access arbitration means 510, N video decoder engines 120-1, 120-2, . . . , 120-N and frame buffer 150.

Motion compensation device 501 has direct memory access means 560, variable-size block buffer 570, interpolation means 580 and selector 590, and is designed with flexible performance and memory size configurations.

Motion compensation device 501 can configure to output motion compensation results to another video decoder engine through the interpolation output 592 terminal or output to frame buffer 150 through a DMA output data port connected to memory access arbitration means 510.

Direct memory access means 560 generates a DMA request after receiving interpolation completion and receives plurality of DMA input data according to maximum DMA burst constraints and block buffer size constraints after receiving a DMA ACK. Then, direct memory access means 560 outputs reference pixel data and generates DMA completion after receiving the plurality of DMA input data. Next, direct memory access means 560 generates interpolation start, receives buffered interpolation data and sends them to memory access arbitration means 510 through DMA output data terminals according to a pre-defined direct memory access protocol. Then, direct memory access means 560 generates addresses to store reference pixel data in variable-size block buffer 570 and to retrieve buffered interpolation data from variable-size block buffer 570, according to decoding parameters, computation level Lc, maximum DMA burst constraints and block buffer size constraints.

Variable-size block buffer 570 has input terminals to receive reference pixel data and selected interpolation data 591, stores reference pixel data retrieved from frame buffer 150 through direct memory access, provides buffered pixel data to interpolation means 580, stores selected interpolation data and provides buffered interpolation data to direct memory access means 560.

Selector 590, controlled by decoding parameters, has an input terminal to receive interpolated data, and either outputs interpolated data to an output terminal in the motion compensation device to provide interpolated output to one of the video decoder engines, or outputs interpolated data to variable-size block buffer 570 to provide selected interpolation data.

Now, operations of the video coding and decoding apparatus configured as described above will be explained.

Motion compensation device 501 issues DMA request 511 according to decoding parameter 561, computation level Lc 562, maximum DMA burst constraint 563 and block buffer size constraint 564. Motion compensation device 501 receives multiple DMA input data 514 after receiving DMA ACK 512, and then issues DMA completion 515. Motion compensation device 501 computes interpolated data according to the decoding mode specified by the decoding parameter, and either outputs the interpolated data to one of video decoder engines 120-1, 120-2, . . . , 120-N through its own interpolation output 592 terminal or outputs the interpolated data to memory access arbitration means 510 using DMA, through DMA output data 513 port.

Memory access arbitration means 510 receives DMA request 511 from the motion compensation device. In addition, memory access arbitration means 510 receives DMA requests from multiple video decoder engines 120-1, 120-2, . . . , 120-N through engine DMA buses 516, 517 and 518, respectively, sets priorities to these DMA requests and sends DMA ACK 512 to each of motion compensation device 501 and multiple video decoder engines 120-1, 120-2, . . . , 120-N according to a pre-defined DMA priority list. Then, memory access arbitration means 510 makes DMA input data and DMA output data streams, provides DMA input data to motion compensation device 501, receives DMA output data 513 from motion compensation device 501, reads data from frame buffer 150 and writes data to frame buffer 150 through main DMA bus 151.

Multiple video decoder engines 120-1, 120-2, . . . , 120-N are connected to memory access arbitration means 510 through engine DMA buses 516, 517 and 518, respectively. Frame buffer 150 is connected to memory access arbitration means 510 through main DMA bus 151.

After receiving DMA ACK 512, direct memory access means 560 receives multiple DMA input data 514, according to maximum DMA burst constraint 563 and block buffer size constraint 564 and outputs reference pixel data. After receiving multiple DMA input data 514, direct memory access means 560 generates DMA completion 515, and then generates interpolation start 582. Direct memory access means 560 receives buffered interpolation data 574 and sends them to memory access arbitration means 510 through its own DMA output data 513 terminal by following a pre-defined direct memory access protocol. Direct memory access means 560 generates block buffer addresses to store reference pixel data, according to decoding parameter 561, computation level Lc 562, maximum DMA burst constraint 563 and block buffer size constraint 564, and retrieves buffered interpolation data 574 from variable-size block buffer 570.

Variable-size block buffer 570 stores reference pixel 571 retrieved from external frame buffer 150 through direct memory access, and provides buffered pixel data 572 to interpolation means 580. Variable-size block buffer 570 stores selected interpolation data 591 and provides buffered interpolation data 574 to direct memory access means 560.

Interpolation means 580 computes and outputs a plurality of interpolated data by applying pre-defined interpolation filters to buffered pixel data 572, and generates interpolation completion 581 after computing all interpolated data 583.

Selector 590, controlled by decoding parameters 561, outputs interpolated data 583 to output terminals of motion compensation device 501 to provide interpolated output 592 to one of the video decoder engines, or outputs interpolated data 583 to variable-size block buffer 570 to provide selected interpolation data 591.

As described above, according to the present embodiment, motion compensation device 501 has selector 590 to select whether interpolated data 583 is outputted to output terminals of motion compensation device 501 or variable-size block buffer 570, so that it is possible to produce the following effect.

Motion compensation device 501 can select, for example, either sending computation results in motion compensation device 501 to another video decoder engine for further processing after motion compensation in a pipelined arrangement for a set of video codecs, such as H.264 video codec, in which subsequent processing after motion compensation is required, or buffering computation results in the block buffer within motion compensation device 501 to be outputted to external frame buffer 150 through DMA access for another set of video codecs, such as MPEG4 video codec, in which there is no subsequent processing in the decoding loop after motion compensation.

### Embodiment 6

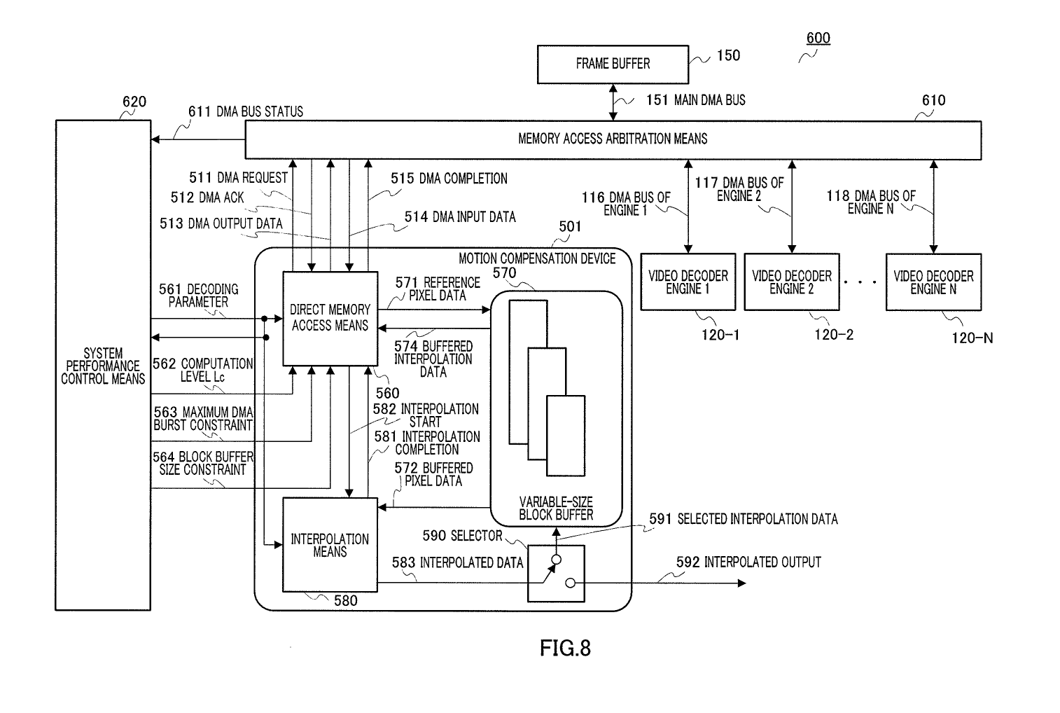

FIG. 8 is a drawing showing the configuration of a video coding and decoding apparatus according to Embodiment 6 of the present invention. The same components as in FIG. 7 are assigned the same reference numerals and descriptions will be omitted.

In FIG. 8, video coding and decoding apparatus 600 is configured to include motion compensation device 501, memory access arbitration means 610, system performance control section 620, N video decoder engines 120-1, 120-2, . . . , 120-N and frame buffer 150.

Motion compensation device 501 can be configured to output motion compensation results to another video decoder engine through interpolation output 592 terminal, or to frame buffer 150 through the DMA output data port connected to memory access arbitration means 610.

Memory access arbitration means 610 receives a DMA request from motion compensation device 501; receives DMA requests from multiple video decoder engines 120-1, 120-2, . . . , 120-N through engine DMA buses 116 to 118, respectively; sets priorities to DMA requests; sends a DMA ACK to each of motion compensation device 501 and multiple video decoder engines 120-1, 120-2, . . . , 120-N according to a pre-defined DMA priority list; makes DMA input data and DMA output data streams; provides DMA input data to motion compensation device 501; receives DMA output data from motion compensation device 501; reads data from frame buffer 150 and writes data to frame buffer 150 through main DMA bus 151; monitors the memory access status of DMA requests from motion compensation device 501 and engine DMA buses; and generates a DMA bus status.

System performance control means 620 has an input terminal to receive a DMA bus status from memory access arbitration means 610 and dynamically changes computation level Lc and maximum DMA burst constraints based on the DMA bus status containing usage details of DMA requests from motion compensation device 501 and engine DMA buses connected to memory access arbitration means 610.

Now, operations of the video coding and decoding device configured as described above.

Motion compensation device 501 issues DMA request 511 according to decoding parameter 561, computation level Lc 562, maximum DMA burst constraint 563 and block buffer size constraint 564. After receiving DMA ACK 512, motion compensation device 501 receives multiple DMA input data 514, and then issues DMA completion 515. Motion compensation device 501 computes interpolated data according to the decoding mode specified by decoding parameters and either outputs the interpolated data to one of video decoder engines 120-1, 120-2, . . . , 120-N through its own interpolation terminal 592, or outputs the interpolated data to memory access arbitration means 610 using DMA through the DMA output data 513 port.

Memory access arbitration means 610 receives DMA request 511 from motion compensation device 510. In addition, memory access arbitration means 610 receives DMA requests from multiple video decoder engines 120-1, 120-2, . . . , 120-N through engine DMA buses 116 to 118, respectively, sets priorities to DMA requests and sends DMA ACK 512 to each of motion compensation device 501 and multiple video decoder engines 120-1, 120-2, . . . , 120-N according to a pre-defined DMA priority list. Then, memory access arbitration means 610 makes DMA input data and DMA output data streams, provides DMA input data to motion compensation device 501, receives DMA output data 513 from motion compensation device 501, reads data from frame buffer 150 and writes data to frame buffer 150 through main DMA bus 151. Next, memory access arbitration means 610 monitors the memory access status of DMA requests 511 from motion compensation device 501 and engine DMA buses and generates DMA bus status 611.

System performance control means 620 dynamically derives computation level Lc 561 and maximum DMA burst constraint 563, based on DMA bus status 611 containing usage details of DMA requests from motion compensation device 501 and engine DMA buses 116 to 118 connected to memory access arbitration means 610.

Multiple video decoder engines 120-1, 120-2, . . . , 120-N are connected to memory access arbitration means 610 through engine DMA buses 116 to 118, respectively. Frame buffer 150 is connected to memory access arbitration means 510 through main DMA bus 151.

After receiving DMA ACK 512, direct memory access means 560 receives multiple DMA input data 514, according to maximum DMA burst constraint 563 and block buffer size constraint 564, and outputs reference pixel data. After receiving multiple DMA input data 514, direct memory access means 560 generates DMA completion 515, and then generates interpolation start 582. Direct memory access means 560 receives buffered interpolation data 574, and sends them to memory access arbitration means 610 through its own DMA output data 513 terminal by following a pre-defined direct memory access protocol. Direct memory access means 560 generates block buffer addresses to store reference pixel data and retrieve buffered interpolation data 574 from variable-size block buffer 570, according to decoding parameters, computation level Lc 562, maximum DMA burst constraint 563 and block buffer size constraint 564.

Variable-size block buffer 570 stores reference pixel data 571 retrieved from external frame buffer 150 through direct memory access, and provides buffered pixel data 572 to interpolation means 580. Variable-size block buffer 570 stores selected interpolation data and provides buffered interpolation data 574 to direct memory access means 560.

Interpolation means 580 computes and outputs a plurality of interpolated data by applying pre-defined interpolation filters to buffered pixel data 572, and generates interpolation completion 581 after computing all interpolated data 583.

Selector 590, controlled by decoding parameters, outputs interpolated data 583 to an output terminal of motion compensation device 501 to provide interpolated output 592 to one of the video decoder engines, or outputs interpolated data 583 to variable-size block buffer 570 to provide selected interpolation data 591.

As described above, in video coding and decoding apparatus 600 according to the present embodiment, system performance control means 620 dynamically derives computation level Lc and maximum DMA burst constraints, based on DMA bus statuses containing usage details of DMA requests from motion compensation device 501 and engine DMA buses. Therefore, it is possible to pre-define system performance, combine a plurality of small DMA requests based on the specified system performance constraints applied to the motion compensation device or dynamic statuses of DMA bus traffic, or divide a large DMA burst access into a plurality of small DMA requests. This enables pre-definition of system performance, and therefore computation level Lc can be pre-defined according to the complexity of computation logics, or dynamically derived according to the DMA bus traffic situation. As a result of this, it is possible to configure the size of an on-chip memory for storing reference pixel data according to the system resource constraint applied to motion compensation device 501. Dynamic configurations of DMA request size and computation level Lc enable the system to optimize the overall system processing throughput in real-time to balance performance between motion compensation device 501 and the other video decoder engines.

The above description is illustration of preferred embodiments of the present invention and the scope of the invention is not limited to this.

Although the name “video decoding and decoding apparatus” is used in the present embodiment for ease of explanation, “decoding device”, “digital video decoding system” and so forth are possible naturally.

Moreover, the type, the number, the connection method and so forth of a motion compensation device, video decoder engines and a buffer constituting the above-described video coding and decoding apparatus, and, in addition, configuration examples of them are not limited to each above-described embodiment.

The disclosure of Japanese Patent Application No. 2008-119267, filed on Apr. 40, 2008, including the specification, drawings and abstract, is incorporated herein by reference in its entirety.

### INDUSTRIAL APPLICABILITY

The video coding and decoding device according to the present invention is suitable for apparatuses to perform high-throughput video coding and decoding. In addition, the video coding and decoding apparatus is applicable to an electronic system that performs video coding and decoding sharing use of an external memory among a plurality of components in the electronic system. For example, it is possible to achieve real-time video decoding in advanced video standards such as H.264/AVC, SMPTE VC1 and China AVS that require frequent accesses to an external memory. In addition, it is possible to provide, for an accelerator in an electronic device, a motion compensation device comprehensively unified into various video encoders and video decoders by specifying a pre-defined system cost limitation and system performance requirements. Moreover, video coding and decoding device according to the present invention is applicable to a motion compensation device used in a digital video encoder and decoder.

### REFERENCE SIGNS LIST

100, 500, 600 Video coding and decoding apparatus
101, 101A, 101B, 101C, 501 Motion compensation device
110, 510, 610 Memory access arbitration means
120-1, 120-2, . . . , 120-N Video decoder engine
150 Frame buffer
160, 560 Direct memory access means
170, 240, 340, 440, 570 Variable-size block buffer
180, 580 Interpolation means
200, 300, 400 DMA Command generator
210, 310, 410 Buffer address generating means
220, 320 420 Configurable sequencer
230, 330 430 Interpolation means
250 Data alignment means
350 Padding means
360, 460 Word-aligning means
370, 470 Chroma interleave means
590 Selector
620 System performance control means

1. A video coding and decoding apparatus having a motion compensation device using motion compensation, the video coding and decoding apparatus comprising:
a plurality of video decoder engines;
a plurality of engine direct memory access buses connected to the plurality of video decoder engines;
a frame buffer;
a main direct memory access bus connected to the frame buffer;
a motion compensation device that issues a direct memory access request according to decoding parameters, computation level Lc, a maximum direct memory access burst constraint and a block buffer size constraint, receives a plurality of direct memory access input data after receiving a direct memory access acknowledgement, issues a direct memory access completion, computes interpolated data according to a decoding mode specified by the decoding parameters and outputs the interpolated data to one of the plurality of video decoder engines; and
a memory access arbitration section that receives the direct memory access request from the motion compensation device, receives direct memory access requests from the plurality of video decoder engines through the engine direct memory access buses, sets priorities to the direct memory access requests, sends the direct memory access acknowledgement to each of the motion compensation device and the plurality of video decoder engines according to a pre-defined direct memory access priority list, makes direct memory access input data and direct memory access output data streams, provides the direct memory access input data to the motion compensation device, reads data from the frame buffer and writes data to the frame buffer through the main direct memory access bus.

2. The video coding and decoding apparatus according to claim 1, wherein the motion compensation device includes:
a direct memory access section that generates the direct memory access request after receiving an interpolation completion from an interpolation section, receives a plurality of direct memory access input data according to the maximum burst constraint and the block buffer size constraint, after receiving the direct memory access acknowledgement from the memory access arbitration section, generates block memory addresses to store reference pixel data in a variable-size block buffer according to the decoding parameters, the computation level Lc, the maximum direct memory access constraint and the block buffer size constraint, outputs the reference pixel data to the variable-size block buffer, generates the direct memory access completion after receiving the plurality of direct memory access input data from the memory access arbitration section, and generates interpolation start;
the interpolation section that has input terminals to receive the decoding parameters, the interpolation start and a plurality of buffered pixel data, computes a plurality of interpolated data by applying pre-defined interpolation filters to the plurality of buffered pixel data, and generates the interpolation completion after computing all the interpolated data; and
the variable-size block buffer that stores the reference pixel data from the frame buffer through direct memory access and provides the buffered pixel data to the interpolation section.

3. The video coding and decoding apparatus according to claim 1, wherein the motion compensation device includes:
a direct memory access command generator that has input terminals to receive the decoding parameters, the direct memory access acknowledgement and direct memory access burst cycles, generates direct memory access requests, receives the direct memory access acknowledgement, counts a number of the direct memory access requests and outputs the direct memory access completion after a counter reaches a number of the direct memory access burst cycles;
a buffer address generating section that has input terminals to receive the decoding parameters, the direct memory access input data and the direct memory access burst cycles, derives block buffer addresses according to the decoding parameters and the direct memory access burst cycles and transfers the direct memory access input data to memory locations in the variable-size block buffer through a reference pixel data terminal;
a variable-size block buffer that has the reference pixel data terminal to receive channeled direct memory access input data, stores the channeled direct memory access input data in pre-defined locations according to the block buffer addresses and outputs buffered pixel data for motion compensation processing;
a data alignment section that has input terminals to receive the decoding parameters, a chroma interleave flag and the buffered pixel data, rearranges the buffered pixel data according to locations in video frames indicated by motion vectors as part of the decoding parameters and the chroma interleave flag indicating a chrominance data format in the frame buffer, provides rearranged pixel data by padding frame boundary pixels, removes unuseful data by word boundary rearrangement, and, when the chroma interleave flag is set, separates interleaved chrominance components and makes chrominance component streams according to a designed chroma pixel data format in the frame buffer;
an interpolation section that has input terminals to receive the decoding parameters, interpolation start and a plurality of rearranged pixel data, computes a plurality of interpolated data by applying pre-defined interpolation filters to the rearranged pixel data, generates the interpolation completion after computing all the interpolated data and outputs the interpolated data; and
a configurable sequencer that has input terminals to receive the decoding parameters, the computation level Lc, the maximum direct memory access burst constraint, the block buffer size constraint and the interpolation completion, allocates direct memory access burst cycles according to a bitstream nature specified by the decoding parameters, system performance limitation specified by the maximum direct memory access burst constraint and system resource limitation specified by the block buffer size constraint and activates the interpolation section at a time being dynamically configured according to the system performance limitation and the system resource limitation.

4. The video coding and decoding apparatus according to claim 1, wherein the motion compensation device includes:
a direct memory access command generator that has input terminals to receive the decoding parameters, the direct memory access acknowledgement and direct memory access burst cycles, generates direct memory access requests, receives the direct memory access acknowledgement, counts a number of the direct memory access requests and outputs the direct memory access completion after a counter reaches a number of the direct memory access burst cycles;
a buffer address generating section that has input terminals to receive the decoding parameters, the direct memory access input data and the direct memory access burst cycles, derives block buffer addresses according to the decoding parameters and the direct memory access burst cycles and transfers the direct memory access input data to a padding section through a reference pixel data input terminal;
a variable-size block buffer that has input terminals to receive rearranged pixel data and the block buffer addresses from the buffer address generating section, stores the rearranged pixel data to proper locations according to the block buffer addresses generated by the buffer address generating section and outputs buffered pixel data to an interpolation section for motion compensation computation;
the padding section that has input terminals to receive the decoding parameters and reference pixel data from the buffer address generating section, duplicates frame boundary pixel values for the reference pixel data located outside video frame boundaries to generate padded pixel data, and judges whether the reference pixel data are outside the video frame boundaries based on frame height and width parameters, motion vectors and a current macroblock position, block position or both positions specified by the decoding parameters;
a word-aligning section that has input terminals to receive the decoding parameters and the padded pixel data from the padding section, removes unuseful data when a first valid pixel data is not aligned with word boundaries to generate aligned pixel data, and judges whether the padded pixel data are aligned with the word boundaries based on sub-pixel positions indicated by the motion vectors of the decoding parameters;
a chroma interleave section that has input terminals to receive the decoding parameters and the aligned pixel data from the word-aligning section, and, when a chroma interleave flag is set, separates interleaved chrominance components and makes chrominance component streams according to a designed chroma pixel data format in the frame buffer to generate the rearranged pixel data;
an interpolation section that has input terminals to receive the decoding parameters, interpolation start and a plurality of buffered pixel data, computes a plurality of interpolated data by applying pre-defined interpolation filters to the buffered pixel data, generates the interpolation completion after computing all the interpolated data and outputs the interpolated data; and
a configurable sequencer that has input terminals to receive the decoding parameters, the computation level Lc, the maximum direct memory access burst constraint, the block buffer size constraint and the interpolation completion, allocates direct memory access burst cycles according to a bitstream nature specified by the decoding parameters, system performance limitation specified by the maximum direct memory access constraint and system resource limitation specified by the block buffer size constraint, and generates interpolation start to activate the interpolation section at a time being dynamically configured according to the system performance limitation and the system resource limitation.

5. The video coding and decoding apparatus according to claim 1, wherein the motion compensation device includes:
a direct memory access command generator that has input terminals to receive the decoding parameters, the direct memory access acknowledgement and direct memory access burst cycles, generates direct memory access requests, receives the direct memory access acknowledgement, counts a number of the direct memory access requests and outputs the direct memory access completion after a counter reaches a number of the direct memory access burst cycles;
a buffer address generating section that has input terminals to receive the decoding parameters, the direct memory access input data and the direct memory access burst cycles, derives block buffer addresses according to the decoding parameters and the direct memory access burst cycles, and transfers the direct memory access input data to memory locations in a variable-size block buffer through a reference pixel data terminal;
the variable-size block buffer that has the reference pixel data terminal to receive channeled direct memory access input data, stores the channeled direct memory access input data in proper locations according to the block buffer addresses and outputs buffered pixel data for motion compensation processing;
a padding section that has input terminals to receive the decoding parameters and buffered pixel data from the variable-size block buffer, duplicates frame boundary pixel values for the buffered pixel data located outside video frame boundaries to generate padded pixel data, and judges whether the buffered pixel data are outside the video frame boundaries, based on frame height and width parameters, motion vectors and a current macroblock position, block position or both positions specified by the decoding parameters;
a chroma interleave section that has input terminals to receive the decoding parameters and the aligned pixel data from the word-aligning section, and, when a chroma interleave flag is set, separates interleaved chrominance components and makes chrominance component streams according to a designed chroma pixel data format in the frame buffer to generate the rearranged pixel data;
an interpolation section that has input terminals to receive the decoding parameters, interpolation start and a plurality of rearranged pixel data, computes a plurality of interpolated data by applying pre-defined interpolation filters to the rearranged pixel data, generates the interpolation completion after computing all the interpolated data and outputs the interpolated data; and
a configurable sequencer that has input terminals to receive the decoding parameters, the computation level Lc, the maximum direct memory access burst constraint, the block buffer size constraint and the interpolation completion, allocates direct memory access burst cycles according to a bitstream nature specified by the decoding parameters, system performance limitation specified by the maximum direct memory access constraint and system resource limitation specified by the block buffer size constraint, and generates interpolation start to activate the interpolation section at a time being dynamically configured according to the system performance limitation and the system resource limitation.

6. The video coding and decoding apparatus according to claim 1, wherein:
the motion compensation device computes interpolated data according to a decoding mode specified by the decoding parameters and either outputs the interpolated data to one of the video decoder engines through an interpolation output terminal or outputs the interpolated data to the memory access arbitration section using direct memory access, through a direct memory access output data port; and
the memory access arbitration section receives the direct memory access request from the motion compensation device, receives the direct memory access requests from the plurality of video decoder engines through the engine direct memory access buses, sets priorities to the direct memory access requests, sends the direct memory access acknowledgement to each of the motion compensation device and the plurality of video decoder engines, according to the pre-defined direct memory access priority list, makes direct memory access input data and direct memory access output data streams, provides the direct memory access input data to the motion compensation device, receives the direct memory access output data from the motion compensation device, reads data from the frame buffer and writes data to the frame buffer through the main direct memory access bus.

7. The video coding and decoding apparatus according to claim 1, wherein:
the direct memory access section generates the direct memory access request after receiving the interpolation completion, receives the plurality of direct memory access input data according to the maximum burst constraint and the block buffer size constraint after receiving the direct memory access acknowledgement, outputs reference pixel data, generates the direct memory access completion after receiving the plurality of direct memory access input data, receives buffered interpolation data, generates interpolation start, receives buffered interpolation data, sends the buffered interpolation data to the memory access arbitration section through a direct memory access output data terminal, by following a pre-defined direct memory access protocol, and generates addresses to store the reference pixel data in a variable-size block buffer and to retrieve the buffered interpolation data from the variable-size block buffer, according to the decoding parameters, the computation level Lc, the maximum direct memory access burst constraint and the block buffer size constraint,
the video coding and decoding apparatus further comprises:
a selector that has input terminals to receive the decoding parameters and interpolated data, the selector being controlled by the decoding parameters and either outputting the interpolated data to an output terminal in the motion compensation device to provide interpolated output to one of the video decoder engines, or outputting the interpolated data to the variable-size block buffer to provide selected interpolation data to one of the video decoder engines; and
the variable-size block buffer that has input terminals to receive reference pixel data and selected data, stores the reference pixel data retrieved from the frame buffer through direct memory access, provides buffered pixel data to the interpolation section, stores the selected interpolation data and provides buffered interpolation data to the direct memory access section.

8. The video coding and decoding apparatus according to claim 1, wherein:
the memory access arbitration section receives the direct memory access request from the motion compensation device, receives the direct memory access requests from the plurality of video decoder engines through the engine direct memory access buses, sets priorities to the direct memory access requests, sends the direct memory access acknowledgement to each of the motion compensation device and the plurality of video decoder engines, according to the pre-defined direct memory access priority list, makes direct memory access input data and direct memory access output data streams, provides the direct memory access input data to the motion compensation device, receives the direct memory access output data from the motion compensation device, reads data from the frame buffer and writes data to the frame buffer through the main direct memory access bus, monitors a memory access status of the direct memory access requests from the motion compensation device and the engine direct memory access bus and generates a direct memory access bus status, and
the video coding and decoding apparatus further comprises:
a system performance control section that has input terminals to receive the direct memory access data bus status from the memory access arbitration section and the decoding parameters, and dynamically changes the computation level Lc and the maximum direct memory access burst constraint, based on the direct memory access bus status containing usage details of the direct memory access requests from the motion compensation section and the engine direct memory access buses connected to the memory access arbitration section.
